(19) United States
(12) Patent Application Publication
(10) Pub. No.: US 2005/0140717 A1
(43) Pub. Date: Jun. 30, 2005

(54) Cleaning apparatus of a wiper

(76) Inventor: Chih-Hung Chen, Jiali Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/024,353

(22) Filed: Dec. 28, 2004

(30) Foreign Application Priority Data
Dec. 30, 2003 (TW) 92137533

(51) Int. Cl. B41J 2/165

(52) U.S. Cl. 347/22

(57) ABSTRACT

A cleaning apparatus for removing ink residue on a wiper. The cleaning apparatus includes a scraper and an absorber. The scraper includes a scraper tip and a supporting part. The scraper tip scrapes ink residue on a wiper to transfer it to the supporting part. The absorber for absorbing ink residue on the supporting part is disposed on the supporting part.

This application claims the benefit of Taiwan application Serial No. 92137533, filed Dec. 30, 2003, the subject matter of which is incorporated herein by reference.

### BACKGROUND OF THE INVENTION

1. Field of the Invention

The invention relates in general to a cleaning apparatus and more particularly to a cleaning apparatus with a scraper and an absorber.

2. Description of the Related Art

Ink-jet printing system has been popularly applied to various office equipments, such as facsimile machine, printer, printing apparatus, and so on. Conventionally, an ink-jet printing system includes a carrier, an ink cartridge, and a maintenance station for the ink-jet head. The ink cartridge is disposed on the carrier which is disposed movably in the ink-jet printing system to proceed printing. Sometimes, the ink cartridge temporarily stops printing and enters into the maintenance station for cleaning ink residue on the ink-jet head. A conventional maintenance station includes a wiper movable with respect to the ink-jet head for wiping the ink residue thereon. As the result, the ink reside removed from the ink-jet head by the wiper would be transferred to the wiper, and the ink cartridge would continue printing or wait for next following printing command. The ink residue removed from the ink-jet head will be accumulated on the wiper and become harden to deteriorate the utilization of the wiper.

Therefore, it is necessary to provide a cleaning product for wiping the ink residue on the wiper. Referring to both FIG. 1A and FIG. 1B, they are two cross-sectional views showing working states of a conventional cleaning apparatus disclosed in U.S. Pat. No. 5,997,128. In FIG. 1A, a ink-jet head 7 is kept stationary and two wipers 4 move along a direction of the arrow in FIG. 1A so that the ink residue 9 on the ink-jet head 7 can be scraped away and the ink residue 9 will be kept on the top of the two wipers 4. Then, an absorber 10 is disposed on the moving route of two wipers 4 and contacts the top of the wipers 4 for absorbing the ink residue 9 to keep the wipers clean, as shown in FIG. 1B. However, the absorber 10 becomes dirty after it is used for a predetermined time, and the conventional design of using the absorber 10 to absorb ink residue will lose its efficacy and become a polluter to the wipers 4.

### SUMMARY OF THE INVENTION

It is therefore an object of the invention to provide a cleaning apparatus including a scraper and an absorber. The cleaning apparatus can remove ink residue on a wiper and absorb the removed ink residue to keep the wiper clean.

The invention achieves the above-identified object by providing a cleaning apparatus for removing ink residue on a wiper. The cleaning apparatus includes a scraper and an absorber. The scraper includes a scraper tip and a supporting part, and the scraper tip scrapes ink residue on a wiper to transfer it to the supporting part. The absorber for absorbing ink residue on the supporting part is disposed on the supporting part.

It is another object of the invention to provide a printing apparatus, including at least a housing, a ink-jet head, a wiper, and a cleaning apparatus. The ink-jet head is movable within the housing for printing, and the wiper, disposed movably with respect to the ink-jet head within the housing, is for wiping ink residue on a the ink-jet head. The cleaning apparatus disposed in the housing includes a scraper and an absorber. The scraper includes a scraper tip and a supporting part, and the scraper tip scrapes ink residue on a wiper to transfer it to the supporting part. The absorber for absorbing ink residue on the supporting part is disposed on the supporting part.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A and FIG. 1B (Prior Art) are two cross-sectional views showing working states of a conventional cleaning apparatus disclosed in U.S. Pat. No. 5,997,128.

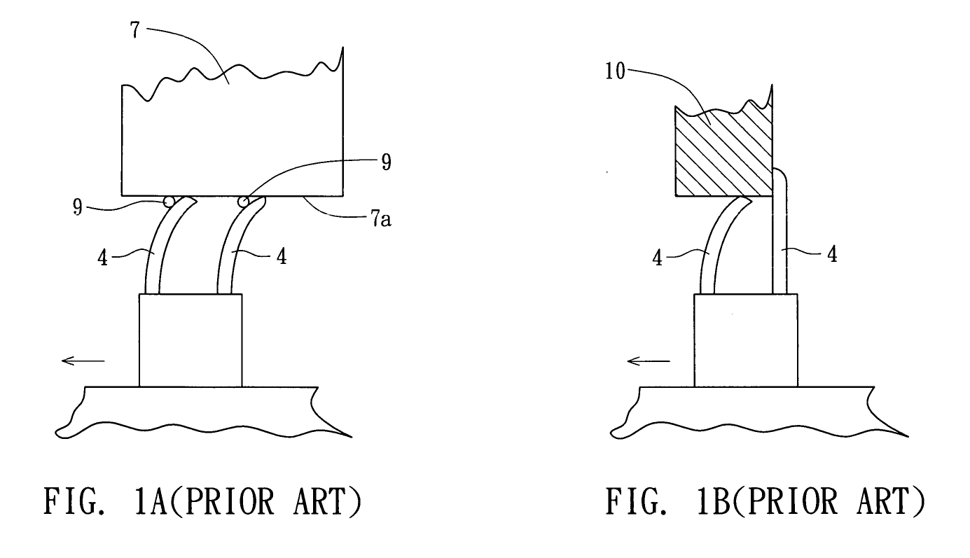

FIG. 2 is a cross-sectional view of a partial printing apparatus according to the first embodiment of the invention.

FIG. 3A is a perspective view showing the wiper and the cleaning apparatus in FIG. 2.

FIG. 3B is a lateral view showing the wiper and the cleaning apparatus in FIG. 3A.

FIG. 4A to FIG. 4D are cross-sectional views showing working states during the cleaning apparatus wiping the ink residue on the wiper in FIG. 3A.

FIG. 5 is a cross-sectional view of a partial cleaning apparatus according to the second embodiment of the invention.

### DETAILED DESCRIPTION OF THE INVENTION

### First Example

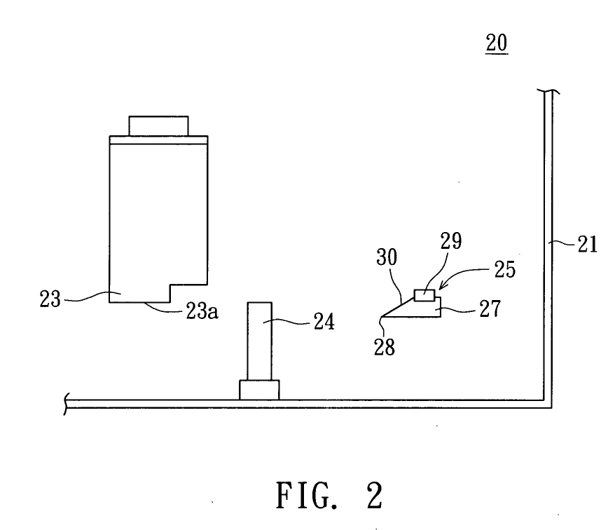

Referring to FIG. 2, it is a cross-sectional view of a partial printing apparatus according to the first embodiment of the invention. In FIG. 2, a printing apparatus 20 includes a housing 21, a ink-jet head 23, a wiper 24, and a cleaning apparatus 25. The ink-jet head 23 for printing process is movable within the housing 21. The wiper 24 for wiping ink residue on the ink-jet head 23 is disposed within the housing 21 and is movable relatively to the ink-jet head 23. The cleaning apparatus 25 disposed within the housing 21 includes a scraper 27 and an absorber 29. The scraper 27 has a scraper tip 28 and a supporting part 30. The ink residue on the wiper 24 is scraped by the scraper tip 28 and transferred to the supporting part 30. Then, the absorber 29 disposed on the supporting part 30 absorbs ink residue on the supporting part 30.

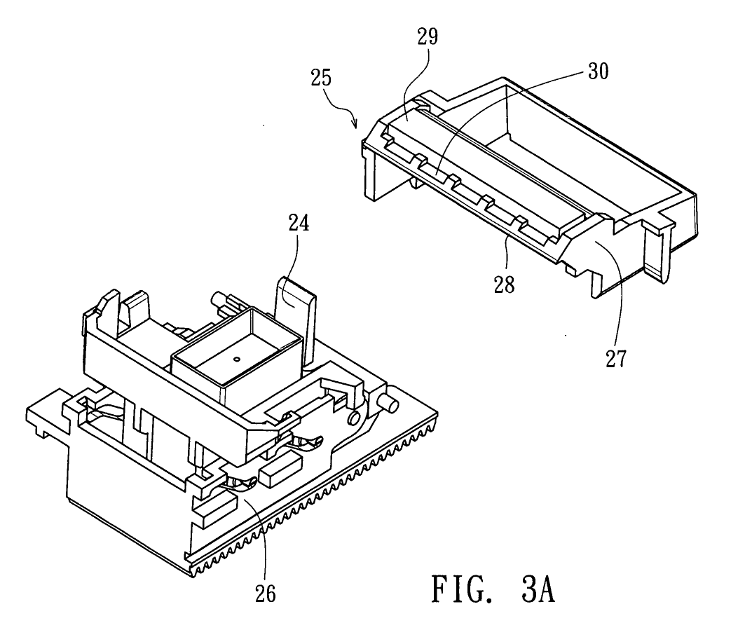

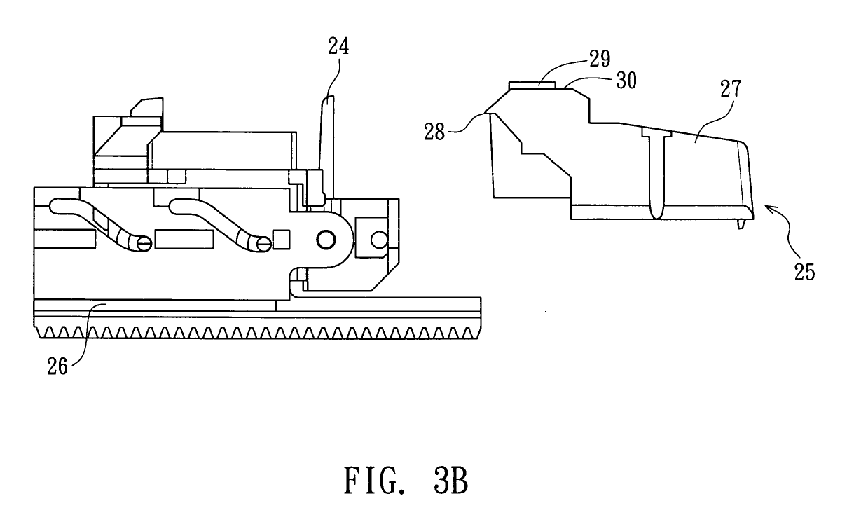

Referring to FIG. 3A and FIG. 3B, FIG. 3A is a perspective view showing the wiper 24 and the cleaning apparatus 25, and FIG. 3B is a lateral view showing the wiper 24 and the cleaning apparatus 25. It is necessary to be noticed here that the wiper 24 is movable within the housing 21 in FIG. 2 by using a move member 26 coupling to the housing 21. As for how the cleaning apparatus 25 effectively scrapes the ink residue on the wiper 24 will be described in detail as follow with its corresponding figures.

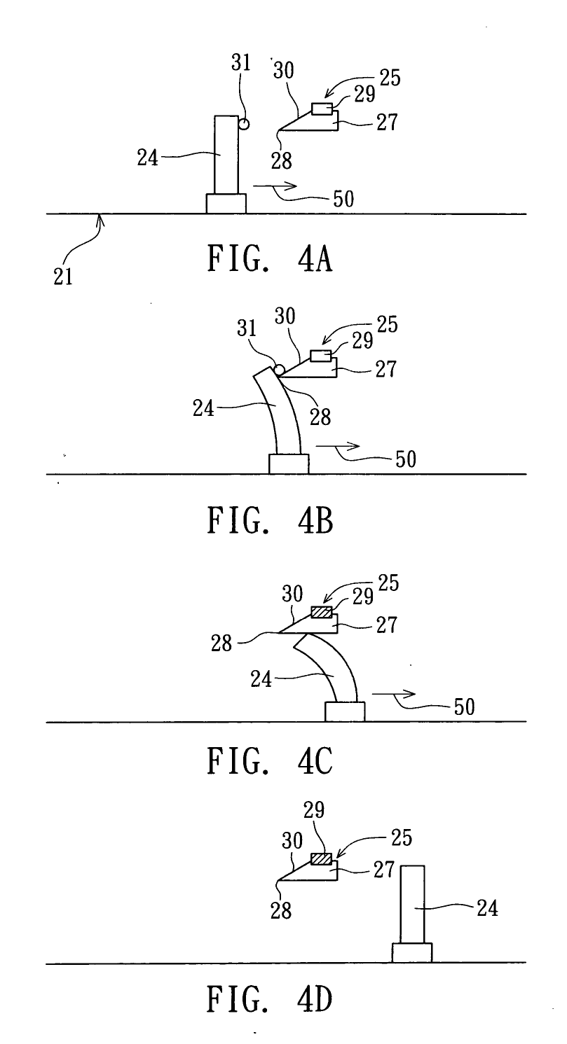

Referring to FIG. 4A to FIG. 4D, they are four cross-sectional views showing working states during the cleaning apparatus 25 scraping the ink residue 31 on the wiper 24. At first, the wiper 24 moves close to the cleaning apparatus 25 within the housing 21 along the direction of the arrow 50, as shown in FIG. 4A. There is an ink residue 31 on the wiper 24, and the scraper tip 28 is lower the top of the wiper 24. In FIG. 4B, the scraper tip 28 contacts the top of the wiper 24. In FIG. 4C, as the wiper 24 moves further in the direction shown by the arrow 50, the wiper 24 is bent leftward, the ink residue 31 is transferred to the supporting part 30 and absorbed by the absorber 29, as shown in FIG. 4C. Therefore, the ink reside 31 on the wiper 24 can be effectively removed by the cleaning apparatus 25.

### Second Example

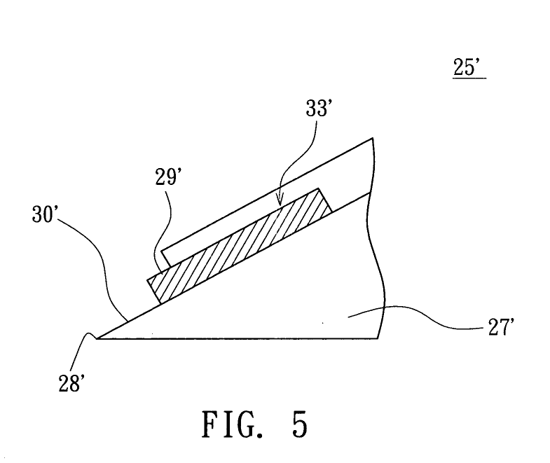

Referring to FIG. 5, it is a cross-sectional view of a partial cleaning apparatus according to the second example of the preferred embodiment of the invention. In FIG. 5, the cleaning apparatus 25′ includes a scraper 27′ and an absorber 29′. The scraper 27′ includes a scraper tip 28′ and a supporting part 30′. There is a predetermined distance between the absorber 29′ disposed on the supporting part 30′ and the scraper tip 28′ to prevent the wiper from contacting the absorber 29′. The supporting part 30′ includes a surface inclined towards the scraper tip 28′. Further, a fillister 33′ on the surface could be designed for containing the absorber 29′. With an aid of the design of the fillister 33′, the absorber 29′ attaches the scraper 27′ more tightly.

The material of the scraper can be metal, plastic, rubber, or a material is proof against ink residue. The material of the absorber can be sponge, sheep's wool, a blotting paper, or a material absorbs ink residue.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A cleaning apparatus for removing an ink residue on a wiper, comprising:
a scraper, including a scraper tip and a supporting part adjacent to the scraper tip; and
an absorber, disposed on the supporting part;
wherein the scraper tip scraps the ink residue on the wiper to transfer the ink residue to the supporting part, and the absorber absorbs the ink residue on the supporting part.

2. The cleaning apparatus according to claim 1, wherein the absorber and the scraper tip are separated for a predetermined distance to prevent the wiper from contacting the absorber.

3. The cleaning apparatus according to claim 2, wherein the supporting part includes a fillister for disposing the absorber thereon.

4. The cleaning apparatus according to claim 2, wherein the supporting part includes a surface inclined towards the scraper tip, and the absorber is disposed on the surface.

5. The cleaning apparatus according to claim 4, wherein the surface further includes a fillister for disposing the absorber thereon.

6. The cleaning apparatus according to claim 1, wherein a first material of the scraper is proof against the ink residue.

7. The cleaning apparatus according to claim 6, wherein the first material of the scraper is metal, plastic, or rubber.

8. The cleaning apparatus according to claim 1, wherein a second material of the absorber is able to absorb the ink residue.

9. The cleaning apparatus according to claim 8, wherein the absorber is a sponge.

10. The cleaning apparatus according to claim 8, wherein the absorber is made of wool.

11. The cleaning apparatus according to claim 8, wherein the absorber is a blotting paper.

12. A printing apparatus, comprising at least:
a housing;
an ink-jet head for printing, deposed movably in the housing;
a wiper for wiping an ink residue on the ink-jet head, deposed movably relatively to the ink-jet head in the housing; and
a cleaning apparatus deposed in the housing for removing an ink residue on the wiper, comprising:
a scraper, having a scraper tip and a supporting part adjacent to the scraper tip,; and
an absorber, disposed on the supporting part;
wherein the scraper tip scraps the ink residue on the wiper to transfer the ink residue to the supporting part, and the absorber absorbs the ink residue on the supporting part.

13. The printing apparatus according to claim 12, wherein the absorber and the scraper tip are separated for a predetermined distance to prevent the wiper from contacting the absorber.

14. The printing apparatus according to claim 13, wherein the supporting part includes a fillister for disposing the absorber thereon.

15. The printing apparatus according to claim 13, wherein the supporting part includes a surface inclined towards the scraper tip, and the absorber is disposed on the surface.

16. The printing apparatus according to claim 15, wherein the surface further includes a fillister for disposing the absorber thereon.

17. The printing apparatus according to claim 12, wherein a first material of the scraper is proof against the ink residue.

18. The printing apparatus according to claim 12, wherein a second material of the absorber is able to absorb the ink residue.
